(19) United States
(12) Patent Application Publication
(10) Pub. No.: US 2009/0009054 A1
(43) Pub. Date: Jan. 8, 2009

(54) Image display device and method of manufacturing the same

(75) Inventors: Toshiaki Kusunoki, Tokorozawa (JP); Motoyuki Miyata, Hitachi (JP); Takashi Naito, Funabashi (JP); Mitsuharu Ikeda, Kokubunji (JP); Yoshiro Mikami, Hitachiota (JP); Etsuko Nishimura, Hitachiota (JP)

Correspondence Address: Stanley P. Fisher;Reed Smith Hazel & Thomas LLP, Suite 1400, 3110 Fairview Park Drive, Falls Church, VA, 22042-4603, US

(73) Assignee: Hitachi, Ltd.

(21) Appl. No.: 12/078,776

(22) Filed: Apr. 4, 2008

(30) Foreign Application Priority Data
Apr. 9, 2007 (JP) 2007-101841

(51) Int. Cl. H01J 63/04

(52) U.S. Cl. 313/496

(57) ABSTRACT

An MIM electron source is comprised of a lower electrode, an insulation film and an upper electrode. By depositing a coat film on the upper electrode through a sputter process using a sputter target of alkaline glass having a modifier component of an alkaline metal oxide or alkaline earth metal oxide, the work function of the upper electrode can be lowered. As a result, the electron emission efficiency can be increased stably.

### CROSS-REFERENCE TO RELATED APPLICATION

The present invention is related to a U.S. Ser. No.______ being filed based on Japanese Patent Application No. 2007-101859 filed on Apr. 9, 2007, the entire content of which is incorporated herein by reference.

### INCORPORATION BY REFERENCE

The present application claims priority from Japanese application JP2007-101841 filed on Apr. 9, 2007, the content of which is hereby incorporated by reference into this application.

### BACKGROUND OF THE INVENTION

The present invention relates to an image display device, especially suitable for an image display device called a flat panel display of spontaneously luminous type using an electron source array and a phosphor screen.

An image display device utilizing minute cold cathode type electron sources capable of being integrated, that is, a field emission display (FED) has been developed. The electron source of this type of image display device is classified into a field emission type electron source and a hot electron type electron source. Belonging to the former type are a Spindt type electron source, a surface conduction type electron source and a carbon nanotube type electron source, whereas for the latter type, thin film type electron sources are included such as an MIM (Metal-Insulator-Metal) type in which metal, insulator and metal are laminated, an MIS (Metal-Insulator-Semiconductor) type in which metal, insulator and semiconductor are laminated and a metal-insulator-semiconductor-metal type.

For example, the MIM type is reported in JP-A-7-65710 and JP-A-10-153979, a MOS type as the MIS type is reported in K. Yokoo et al., J. Vac. Sci. Techonol. B11(2), pp. 429-432 (1993), a HEED type as the metal-insulator-semiconductor-metal type is reported in N. Negishi et al., Jpn. J. Appl. Phys. Vol. 36, Pt. 2, No. 7B, pp. L939-L941, the EL type is reported in S. Okamoto, OYO BUTURI, Vol. 63, No. 6, pp. 592-595 (1994) and the porous silicon type is reported in N. Koshida, OYO BUTURI, Vol. 66, No. 5, pp. 437-443 (1997).

These electron sources can be arrayed in a matrix having a plurality of rows (for example, in the horizontal direction) and a plurality of columns (for example, in the vertical direction) and many phosphor materials corresponding to the individual electron sources are arranged in vacuum, thus forming an image display device.

### SUMMARY OF THE INVENTION

In applying the electron source array to the display device, it is to be understood that an electron emission portion having a lower work function can emit more electrons irrespective of the type of electron source, that is, field emission type or hot electron type. In the hot electron type electron source, the lower the band offset at the interface between an electron emission film and an electron accelerating layer, the larger the diode current even at a low drive voltages, permitting the emission current to increase. Further, the smaller the gas adsorption to the electron emission surface, the more the emission current can be increased.

For the above reasons, it is preferable that either alkaline metals or alkaline earth metals efficient in lowering the work function of the electron emission film and having an ability to prevent gas adsorption to the electron emission film with the aid of the catalizer effect or their compounds are coated or deposited on the electron emission film or added therein. The present inventors disclose that, in a method of adding the alkaline metals, the alkaline earth metals or their compounds such as their oxides to the electron emission film surface or in it, an alkaline metal, an alkaline earth metal or its compound is added by coating, drying and sintering an aqueous solution of, for example, a salt of the alkaline metal or alkaline earth metal, thereby making it possible to increase the amount of electron emission, to lower the drive voltage and to prevent the gas adsorption.

In addition to the aforementioned method of forming a film through a wet process based on coating of the aqueous solution, a method of forming a film through a dry process such as vacuum evaporation or sputtering is available as a method of introducing alkaline or alkaline earth metals into the electron emission film.

The vacuum evaporation or deposition, however, faces such a problem that Cs or Rb especially highly effective to reduce the work function has a high vapor pressure and is therefore easy to desorb. For other metals belonging to the alkaline or alkaline earth metal, there is a difficulty in forming a uniform thin film in large area through the evaporation process.

On the other hand, as for the sputtering method, a uniform film of large area can be formed easily but due to the high reactivity of the alkaline metal or alkaline earth metal has, a target of pure metal excepting magnesium is difficult to use. There also arises a problem that a target of alloy of the alkaline metal or alkaline earth metal with other metals has a high reactivity to suffer difficulties in formation a target and also impairment of stability.

Contrarily, according to the wet process of coating and drying an aqueous solution that the present inventors have already disclosed, the amount of coating can be adjusted with ease. However, after the liquid is drained away, unevenness of water mark will sometimes occur, and further, such problems as humidity absorption and alkaline corrosion of wiring conductors are likely to take place.

An object of this invention is to provide a method of coating or adding an alkaline metal or alkaline earth metal to an electron emission film with high uniformity to thereby realize an image display device with high brightness.

An MIM electron source is constituted with a lower electrode, a tunnel insulator film and an upper electrode being an electron emission film. After the upper electrode is formed, a sputtering film is formed on the upper electrode by using a sputter target of alkaline glass having a modifier component such as an alkaline metal oxide or alkaline earth metal oxide, so that the work function of the upper electrode can be lowered.

For example, any of boron, aluminum, silicon, germanium and phosphorus can be used as a frame component of the alkaline glass. Among them, boron, aluminum or silicon is suitable, with silicon being especially suitable.

As the alkaline metal, cesium, rubidium, potassium, sodium or lithium may be used. Then, when two kinds of the above elements are mixed at the same molar mass, the mixed alkaline effect enables to produce an alkaline glass of especially high chemical stability. Among the above elements, a cesium oxide having a low work function and a potassium oxide being cheap are practically advantageous and a compound containing the two kinds of oxides at the same molar mass is particularly effectual.

Barium, strontium, calcium or magnesium can be used as the alkaline earth metal. Among these elements, barium is practically advantageous as it has a low work function and it can be added to glass at a large amount.

By using the aforementioned means useful to attain the above object, the alkaline metal or the alkaline earth metal can be stabilized in glass in the form of an oxide to thereby permit production of a sputter target and also a film having even a large area can be formed uniformly by the RF sputtering. This ensures that an image display device of high brightness can be materialized.

According to the present invention, the alkaline metal or alkaline earth metal deposited by sputtering diffuses into the upper electrode of the MIM electron source to reduce the work function of the upper electrode, while aluminum wiring conductors used for scanning electrodes or signal electrodes can be prevented from being corroded.

Other objects, features and advantages of the invention will become apparent from the following description of the embodiments of the invention taken in conjunction with the accompanying drawings.

### BRIEF DESCRIPTION OF THE DRAWINGS

FIG. 1 is a schematic plan view of an exemplified image display device using an MIM type thin film electron source for explaining embodiment 1 of the present invention.

FIG. 2 is a diagram to explain the operational principle of the thin film type electron source.

FIGS. 3A-3C are diagrams following FIG. 2 and illustrating a method of producing the thin film type electron source of the invention.

FIGS. 4A-4C are diagrams following FIGS. 3A-3C and illustrating the thin film type electron source production method of the invention.

FIGS. 5A-5C are diagrams following FIGS. 4A-4C and illustrating the thin film type electron source production method of the invention.

FIGS. 6A-6C are diagrams following FIGS. 5A-5C and illustrating the thin film type electron source production method of the invention.

FIGS. 7A-7C are diagrams following FIGS. 6A-6C and illustrating the thin film type electron source production method of the invention.

FIGS. 8A-8C are diagrams following FIGS. 7A-7C and illustrating the thin film type electron source production method of the invention.

FIGS. 9A-9C are diagrams following FIGS. 8A-8C and illustrating the thin film type electron source production method of the invention.

FIGS. 10A-10C are diagrams following FIGS. 9A-9C and illustrating the thin film type electron source production method of the invention.

FIGS. 11A-11C are diagrams following FIGS. 10A-10C and illustrating the thin film type electron source production method of the invention.

FIGS. 12A-12C are diagrams following FIGS. 11A-11C and illustrating the thin film type electron source production method of the invention.

FIGS. 13A-13C are diagrams following FIGS. 12A-12C and illustrating the thin film type electron source production method of the invention.

FIGS. 14A-14C are diagrams following FIGS. 13A-13C and illustrating the thin film type electron source production method of the invention.

FIGS. 15A-15C are diagrams following FIGS. 14A-14C and illustrating the thin film type electron source production method of the invention.

FIG. 16 is a diagram following FIGS. 15A-15C and illustrating the thin film type electron source production method of the invention.

FIG. 17 is a schematic plan view of an exemplified image display device using a surface conduction type thin film electron source for explaining embodiment 2 of the present invention.

FIG. 18 is a schematic plan view of an exemplified image display device using a field emission type thin film electron source for explaining embodiment 3 of the present invention.

### DETAILED DESCRIPTION OF THE EMBODIMENTS

The embodiments of the present invention will be described in greater detail with reference to the accompanying drawings. Firstly, a first embodiment of an image display device will be described by way of example of the image display device using an MIM type electron source.

### Embodiment 1

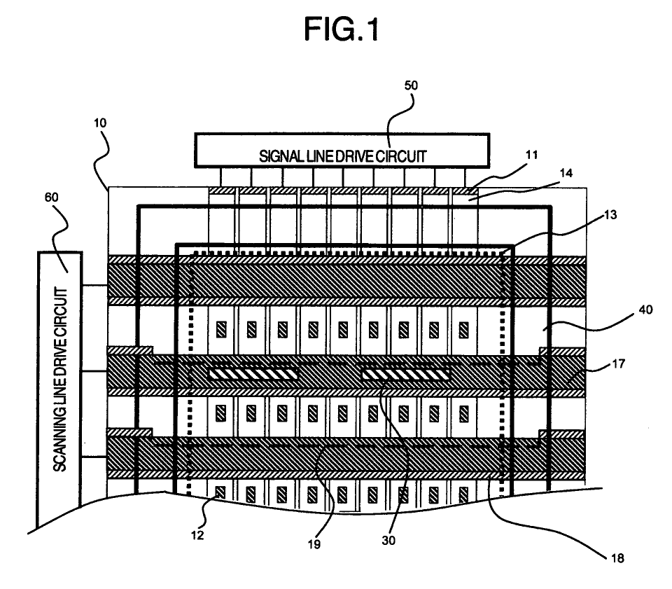

Referring now to a schematic plan view of FIG. 1, as embodiment 1 of the invention, an example of an image display device using an MIM type electron source will be described.

In FIG. 1, a plane of one substrate (cathode substrate) 10 having the electron source and a frame glass 40 are principally shown with omission of the other substrate (anode substrate) formed with phosphor materials.

Formed on the cathode substrate 10 are a lower electrode 11 constituting a signal line (data line) connected to a signal line drive circuit 50, an upper electrode 13 functioning as an electron emission electrode, an upper bus electrode 17 (for feeding electric power to the upper electrode) connected to a scanning line drive circuit 60 and arranged orthogonally to the signal line, a contact electrode 18 overlying the upper bus electrode 17 for connection to the upper electrode, a step structure 19 (a visor structure shaped to allow the scanning electrode to protrude from the edge of an upper bus electrode) for partitioning the upper electrode 13 in respect of the individual scanning electrode, and other functional films to be described later. An electron source array (electron emission portion) is constructed of upper electrodes 13 each of which is arranged between the adjacent upper bus electrodes 17 above the lower electrode 11 and is laminated on the lower electrode 11 via an insulator layer 12 so that electrons may be emitted from a part of the insulator layer 12 (this part being termed a tunnel insulator layer) which is a thin layer portion surrounded by a thick protective insulator layer 14 adapted to restrict the electron emission portion. The cathode electrode of this invention is featured in that an alkaline glass having a modifier component of an alkaline metal oxide or alkaline earth metal oxide is coated on or added to the electron emission films.

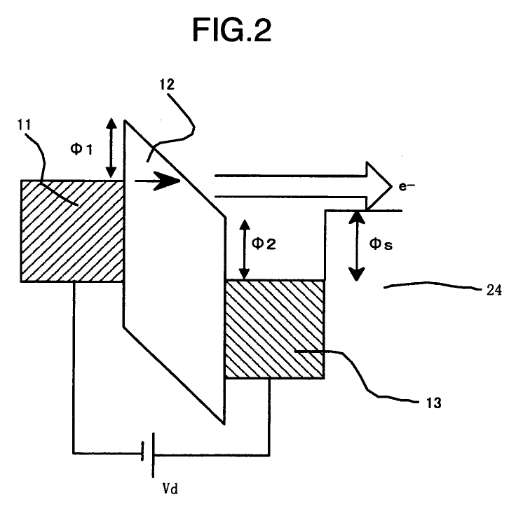

The principle of the MIM type electron source will be described by making reference to FIG. 2. When, in the electron source, a drive voltage V_{d} is applied across the upper electrode 13 and the lower electrode 11 and an electric field inside the tunnel insulator layer 12 is set to 1 to 10 MV/cm, electrons in the vicinity of the Fermi level inside the lower electrode 11 transmit through the barrier wall by the tunnel phenomenon so as to be injected to the conduction band in insulator layer 12 which functions as an electron accelerating layer, turning into hot electrons which in turn flow into the conduction band in the upper electrode 13. Among the hot electrons, those having energy in excess of a work function φₛ and reaching the surface of the upper electrode 13 are emitted to vacuum 24. Accordingly, when the work function φₛ of the upper electrode 13 is lowered by doping alkaline metal, alkaline earth metal or a compound of alkaline metal or alkaline earth metal into the upper electrode 13, a greater number of electrons are emitted and the electron emission efficiency can be improved.

Further, in proportion to the lowering of a band offset φ₂ at the interface between the insulator layer 12 and the upper electrode 13 by adding alkaline metal, alkaline earth metal or its compound such as its oxide, the electric field applied to the insulator layer 12 is intensified for the same drive voltage V_{d}, with the result that a lower drive threshold voltage can be obtained.

Reverting to FIG. 1, a spacer 30 is arranged on the upper bus electrode 17 of cathode substrate 10 in such a manner that it can underlie the black matrix (not shown) of the phosphor screen substrate so as to be concealed thereby. The lower electrode 11 functioning as the signal electrode wiring is connected to the signal line drive circuit 50 and the upper bus electrode 17 functioning as the scanning electrode wiring is connected to the scanning line drive circuit 60. The frame glass 40 is bonded to the cathode substrate 10 and phosphor screen substrate (not shown) with frit glass and the interior is vacuum evacuated.

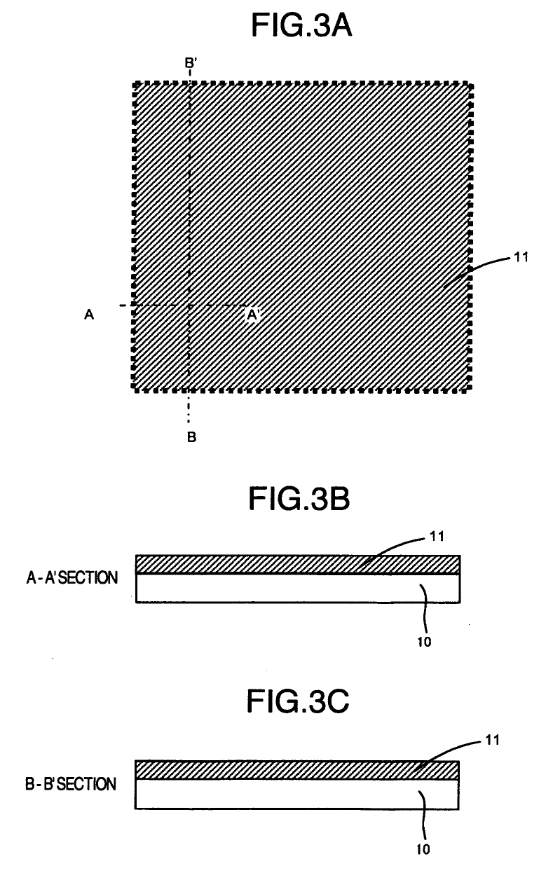

An embodiment of a method of manufacturing the image display device of the present invention will be described with reference to FIGS. 3A to 15C. Firstly, as shown in FIGS. 3A-3C, a metal film for the lower electrode 11 is formed on the glass substrate 10. As a material of the lower electrode 11, an Al family material is used. The reason why the Al family material is used is that a good quality insulator film can be formed through anodization. Here, an Al—Nd alloy including Nd doped at an atomic weight of 2% is used. For formation of the film, a sputtering process, for example, is used. The film thickness is set to 600 nm.

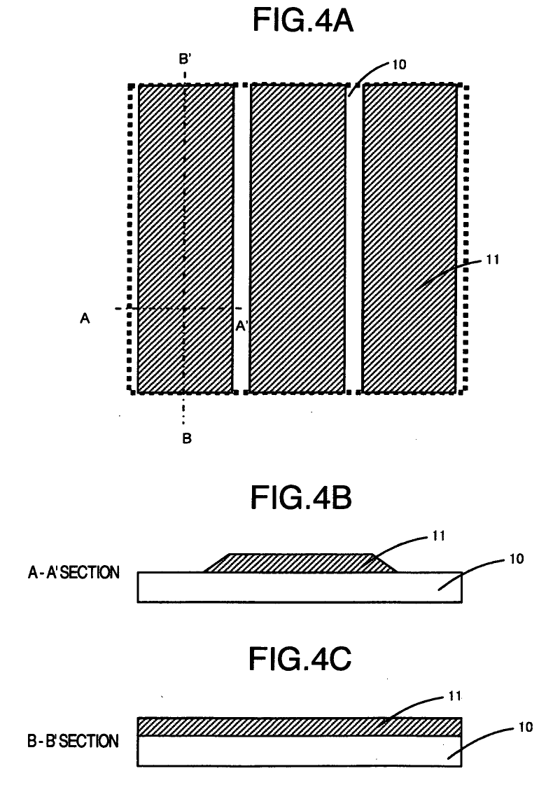

After the film formation, the lower electrode 11 is partitioned to stripes through a patterning process and an etching process (see FIGS. 4A-4C). The electrode width of the lower electrode 11 differs depending on the size and resolution of the image display device and approximates a pitch of the sub-pixels, amounting to about 100 to 200 microns. Because of the simplified stripe structure and its wide width that the electrode has, patterning of resist can be performed through an inexpensive proximity exposure or printing process.

Since the lower electrode 11 is the lowermost or bottom film on the cathode substrate and various kinds of films are stacked thereon, it is preferable to process the edge of this electrode being tapered. Then, wet etching is employed using etching liquid of an aqueous solution mixed with phosphoric acid, acetic acid or nitric acid. By increasing the percentage of nitric acid, resist retreat can be promoted during etching and the edge can be tapered.

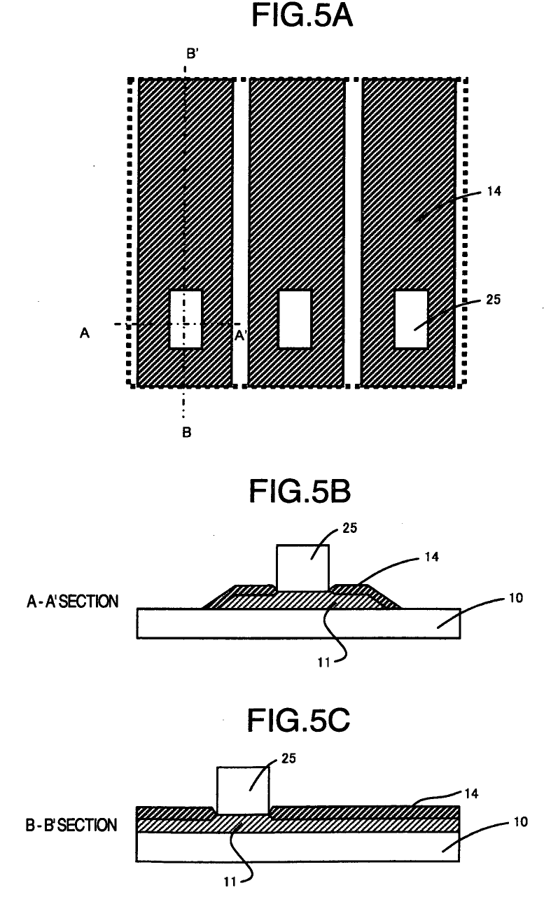

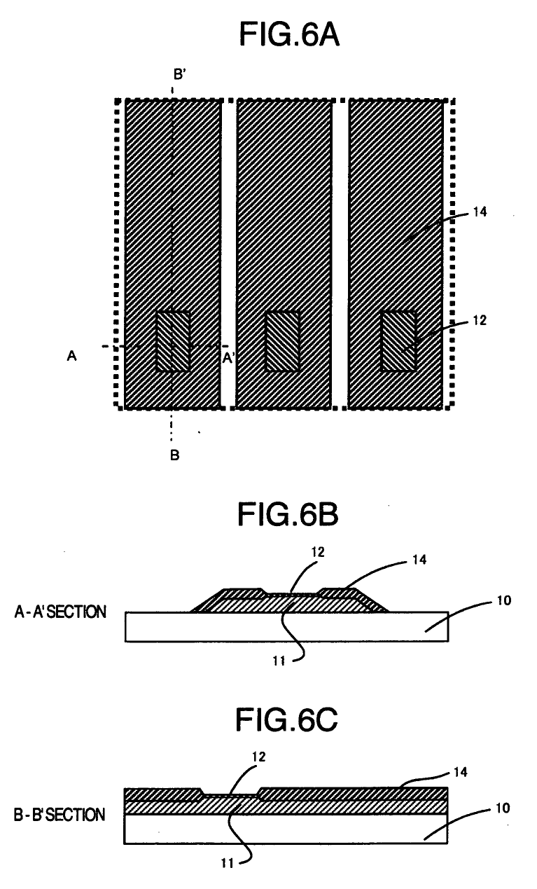

Next, a protective insulator layer 14 adapted to restrict the electron emission portion and to prevent concentration of electric field at the edge of the lower electrode 11 and the insulation layers 12 as well are formed. Firstly, as shown in FIGS. 5A-5C, a portion for electron emission on the lower electrode 11 is masked with a resist film 25 and the other rest portion is selectively thickened through anodization to form the protective insulation layer 14. When the formation voltage is set to be 200V, the protective insulation layer 14 of a thickness of about 280 nm can be formed. Thereafter, the resist film 25 is removed and the surface of the remaining portion of upper electrode 11 is subjected to anodization. For example, with the formation voltage being set to 4V, the insulation layer of a thickness of about 8 nm (tunnel insulation layer) 12 can be formed (see FIGS. 6A-6C).

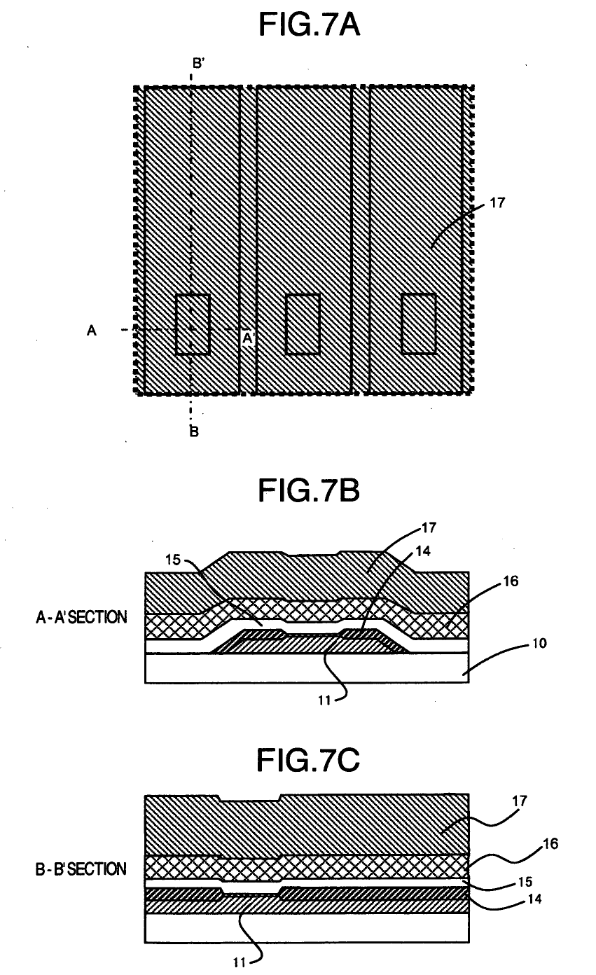

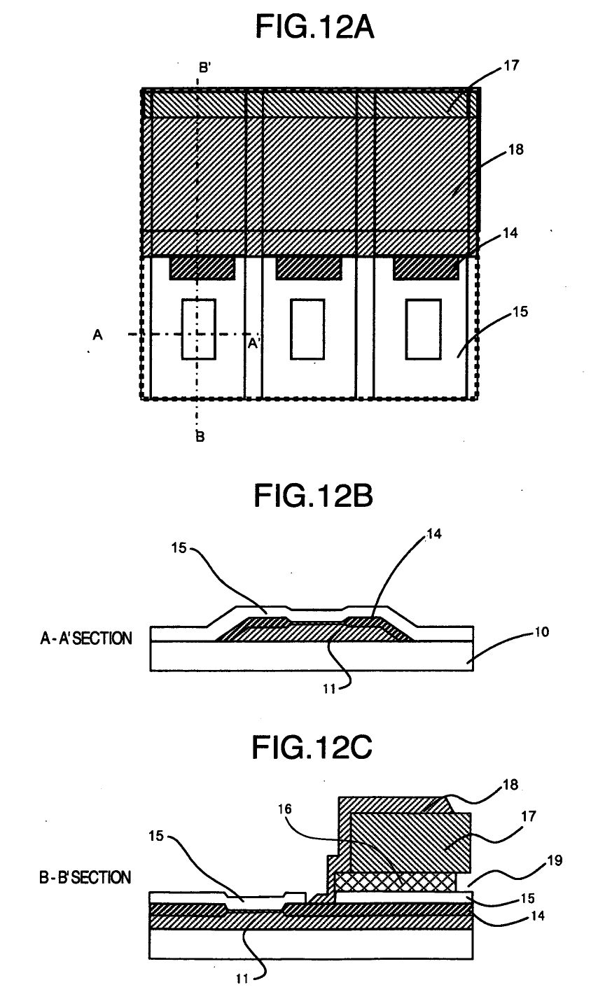

Subsequently, an inter-layer film (inter-layer insulation film) and a metal film for the upper bus electrode 17 which serves as a feed line to the upper electrode 13 are deposited , for example, through a sputtering process (see FIGS. 7A-7C). As the inter-layer film, a silicon oxide or silicon nitride film, for example, can be used. Here, a laminated film of silicon nitride film 15 and silicon film 16 being 200 nm and 300 nm in thickness, respectively, is used. If the protective insulation layer 14 formed through the anodization has pinholes, the silicon nitride film 15 fills up the defects, having the role of maintaining insulation between the lower electrode 11 and the upper electrode 17. The silicon film 16 will be used to form an undercut 19 later (see FIGS. 12A-12C) at a portion corresponding to the side surface of the upper bus electrode 17, thereby the individual upper electrodes 13 are separated.

A metal film for the upper bus electrode 17 is deposited through a sputtering process, for example. The upper bus electrode 17 is used as a scanning electrode and is therefore required to have a lower resistance than the lower electrode 13 working as a data electrode. Here, pure Al having low resistivity is used and its thickness is set to 4.5 μm in order to reduce the wiring resistance.

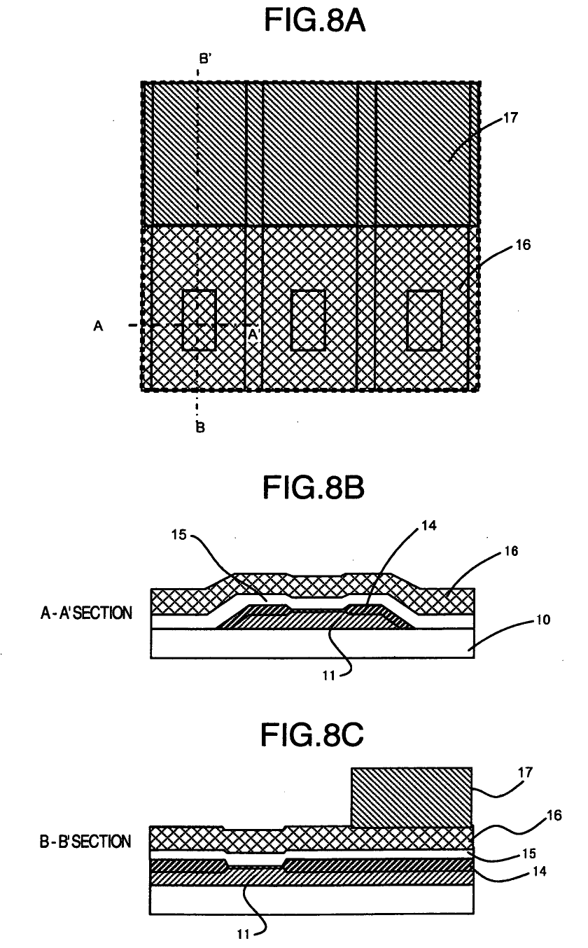

Next, the upper bus electrode 17 is formed. The upper bus electrode 17 is orthogonal to the lower electrode 11 and is disposed beside the electron emission portion. For etching, wet etching using an aqueous solution mixed with, for example, phosphoric acid, acetic acid and nitric acid is used (see FIGS. 8A-8C).

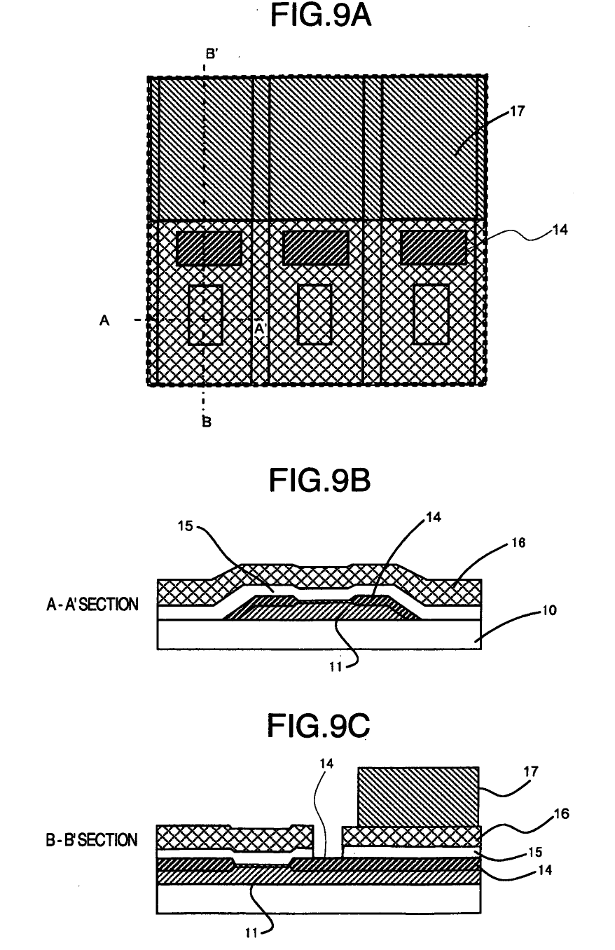

Subsequently, a through-hole is formed in the inter-layer film 15, 16 on the field insulation film 14 at a location between upper bus electrode 17 and tunnel insulation layer 12. In etching, dry etching using an etching gas of a main component of CF₄ or SF₆, for example, is used in order to etch the silicon nitride film 15 and silicon film 16 simultaneously (see FIGS. 9A-9C).

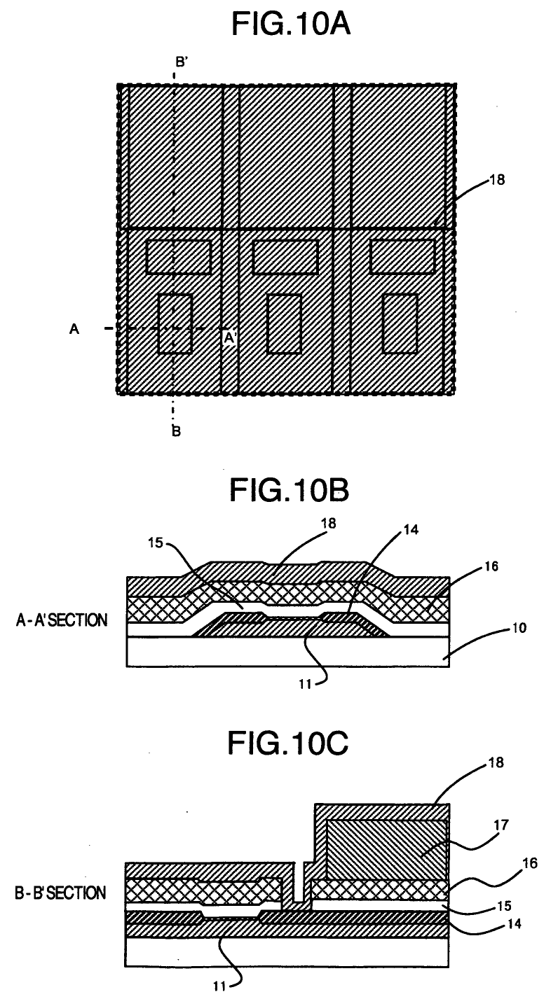

Then, a metal film for the contact electrode for electrical interconnection of the upper bus electrode and upper electrode is formed by sputtering. For the metal film for the contact electrode, an Al—Nd alloy doped with Nd at a 2 atomic weight % is used like the lower electrode. For the film formation, a sputtering process, for example, is used. The film thickness is set to 300 nm (FIGS. 10A-10C).

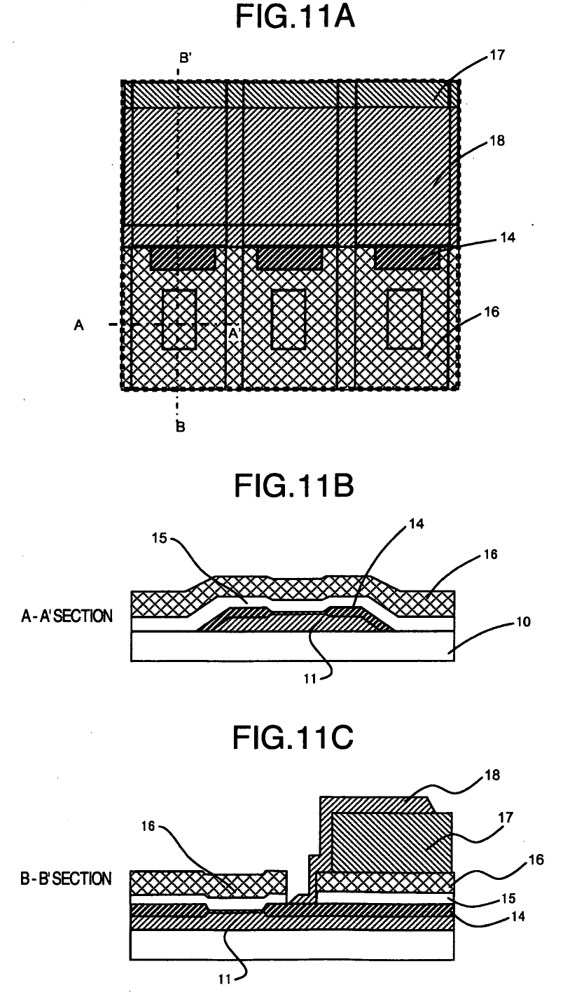

Thereafter, the contact electrode 18 is formed (see FIGS. 11A-11C). Like the lower electrode 11, the contact electrode 18 is processed to be tapered, and to this end, it is subjected to wet etching using etching liquid of an aqueous solution mixed with phosphoric acid, acetic acid and nitric acid. By increasing the percentage of nitric acid, resist retreat during etching can be promoted and the edge can be tapered.

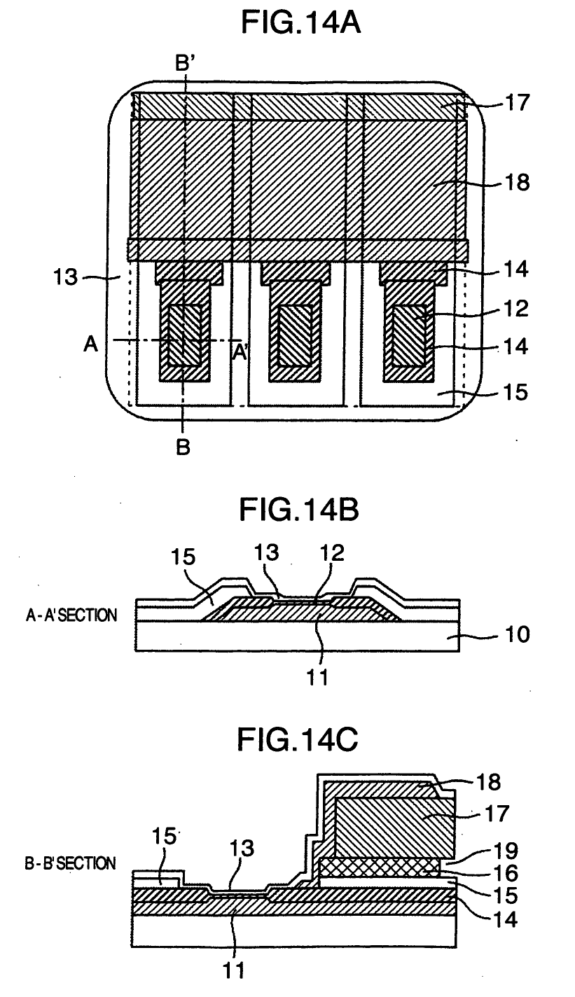

The contact electrode 18 is shaped as shown in FIGS. 11A-11C such that its end surface confronting the tunnel insulation layer 12 lies over the through-hole and its end surface opposite to the tunnel insulation layer 12 overlies the upper bus electrode 17. By forming the end surface of contact electrode 18 within the through-hole, the contact portion can be formed on the field insulation film 14 and therefore, the upper electrode 13 to be formed later (see, FIGS. 14A-14C) can be lowered from the upper bus electrode 17 to the field insulation layer 14 without routing through over the step at the edge of the silicon nitride film 15 and the silicon film 16. Accordingly, disconnection of the upper electrode 13 at the step can be prevented.

Then, as shown in FIGS. 12A-12C, by dry-etching the inter-layer silicon film 16 at a higher selection rate than the silicon nitride film 15, the undercut 19 can be formed beneath the opposing end side of the upper bus electrode 17. The dry-etching is carried out by using a mixture gas of CF₄ and O₂ or a mixture gas of SF₆ and O₂. This kind of gas etches both Si and SiN but by optimizing the ratio of O₂ (for example, CF₄:O₂=2:1), the etching selection rate of Si can be enhanced. When a film of the upper electrode 13 is formed later, the undercut 19 functions to separate the upper electrodes 13 in respect of the individual upper bus electrodes 17 (individual scanning lines).

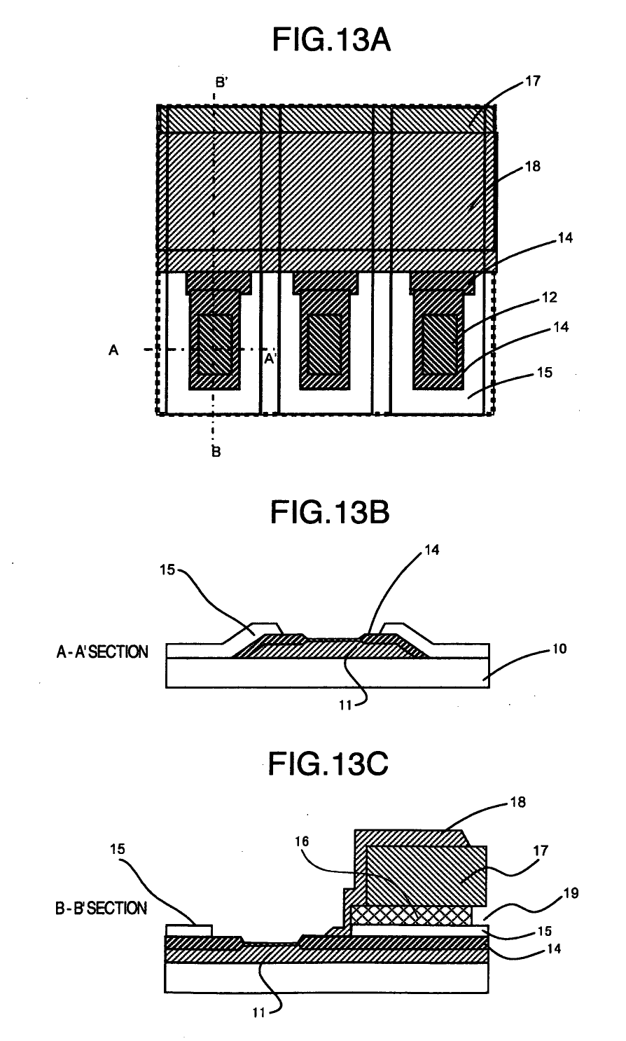

Subsequently, the silicon nitride film 15 on the electron emission portion is processed to expose the electron emission portion. Etching to this end is dry-etching using an etching agent having, for example, CF₄ or SF₆ as a main component (see FIGS. 13A-13C).

Then, a film of upper electrode 13 is formed through a sputtering process. Effectually used as a material of the upper electrode 13 is a platinum group of 8 group or a noble metal of 1b group exhibiting a high transmission factor for hot electrons. Especially, a film of Pd, Pt, Rh, Ir, Ru, Os, Au or Ag or a film of their lamination is effectual. Here, for example, a laminated film of Ir, Pt and Au with a thickness ratio of 1:3:3 is used having a total thickness, for example, of 3 nm (see FIGS. 14A-14C).

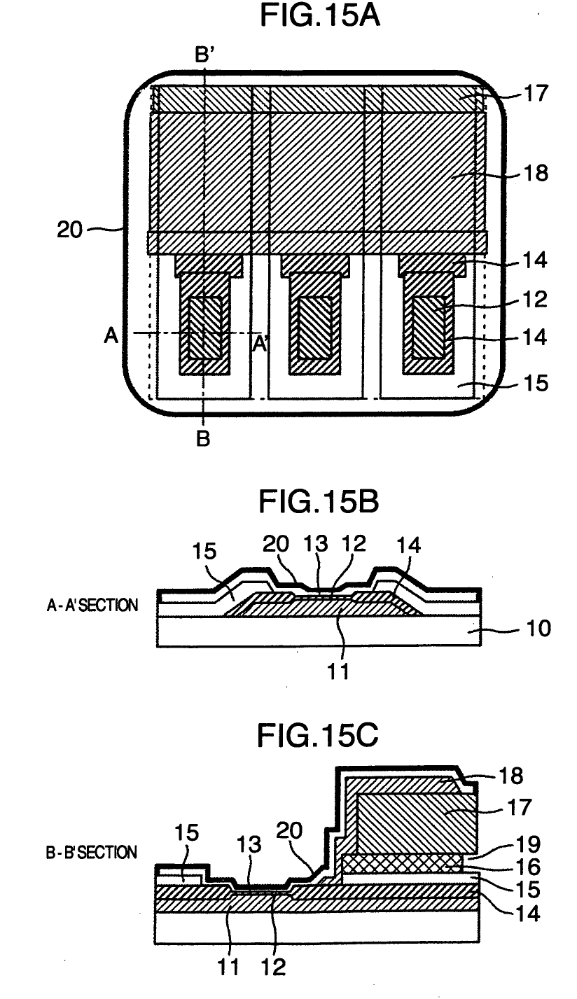

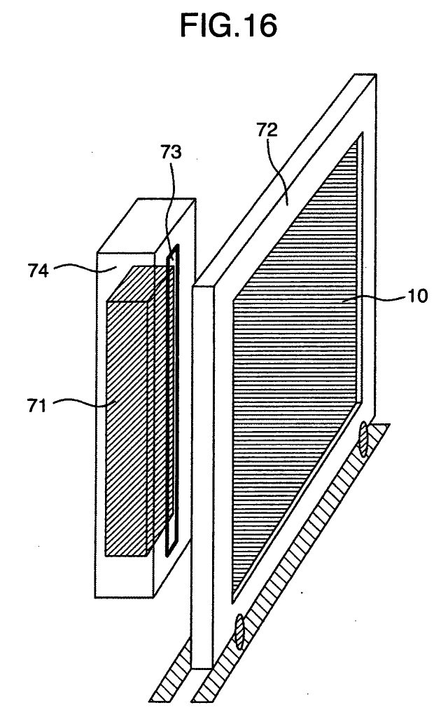

Thereafter, a film of alkaline glass 20 is formed on the upper electrode 13 by RF sputtering using a sputter target 71 of alkaline glass (FIGS. 15A-15C). For sputtering, the substrate 10 is mounted on a carrier 72 in-line as shown in FIG. 16 and is then passed at a constant speed in front of a shield electrode 74 for the sputter target, engraved with a slit 73 for film thickness correction, with the result that a thin alkaline glass layer of about 1 nm thickness can be formed over the whole substrate at high uniformity of a film thickness with a waviness distribution less than 5%, demonstrating that the high uniformity can be realized in comparison with about 10% by the conventional wet process.

In this manner, the glass film containing the alkaline metal oxide or alkaline earth metal oxide of low work function can be formed on the upper electrode and the work function at the surface can be lowered. It will be appreciated that the formation of alkaline glass film may be carried out before the formation of upper electrode 13 to add alkaline glass to an interface between the tunnel insulation layer 12 and the upper electrode 13 to effectually reduce the band offset at the interface. Irrespective of the order of the film formation, the alkaline glass can be mixed with the upper electrode 13 during a heat treatment of paneling process to be described later, thus being partly alloyed and added to the upper electrode.

As the modifier of the alkaline glass, an oxide, peroxide or hyperoxide of an alkaline metal such as cesium, rubidium, potassium, sodium or lithium, or an oxide of an alkaline earth metal such as barium, strontium, calcium or magnesium is effective. Among these elements, a material having far lower work function is preferable and in the case of alkaline metal, the preference is ranked in the order of cesium, rubidium, potassium, sodium and lithium and in the case of the alkaline earth metal, the preference is ranked in the order of barium, strontium, calcium and magnesium. When the alkaline metal is used particularly, two kinds of alkaline metals may preferably be added at the same molar mass in order that the mixed alkaline effect for improving the chemical stability of glass is manifested. As the frame component of alkaline glass, boron, aluminum, silicon, germanium or phosphorous can be listed, and among them, a material hampering the electron emission as little as possible is preferable, especially including preferably an oxide of boron, aluminum or silicon having a characteristic of a low density of states in the valence electron band so that the transmission factor of hot electrons is high. Further, among them, preference is graded in the order of boron, aluminum and silicon in consideration of the fact that the lower the electronegativity, the more the work function can be prevented from increasing, and silicon is especially recommended because it has strong frames of bonds and is advantageous in providing highly stable glass.

In the present embodiment, for the modifier component, the cesium oxide of low work function and the cheap potassium oxide are used in the case of the alkaline metal oxide, and the barium oxide having a low work function and being likely to be added to glass by a large amount is used in the case of the alkaline earth metal oxide. For the frame component, the boron oxide having good electron transmission factor or the silicon oxide having a stable frame is the principal material, the material consumption of which is reduced within a range capable of maintaining the glass property. Specifically, glass is used which contains any one of combinations of B₂O₃—Cs₂O, B₂O₃—Cs₂O—K₂O, B₂O₃—Cs₂O—K₂O—BaO, SiO₂—Cs₂O, SiO₂—Cs₂O—K₂O and SiO₂—Cs₂O—K₂O—BaO.

Subsequently, the cathode substrate and anode substrate constituting the image display device are put together via the spacer and frame member, sintered and sealed to each other by using frit seal through a high temperature process at 400 to 450° C. Each of the alkaline metal and alkaline earth metal compounds in the glass has a strong ionization tendency and therefore, during the above process, electrons are supplied to the upper electrode made of a noble metal so as to lower its work function, thereby improving the electron emission efficiency.

Embodiments of the present invention using a surface conduction type electron source array and a field emission type electron source array will hereinafter be described in embodiments 2 and 3, respectively. The basic principle of the invention is the same in that the work function of the electron emission film is reduced and hence, only the construction and effect of the image display device will be described in brief.

### Embodiment 2

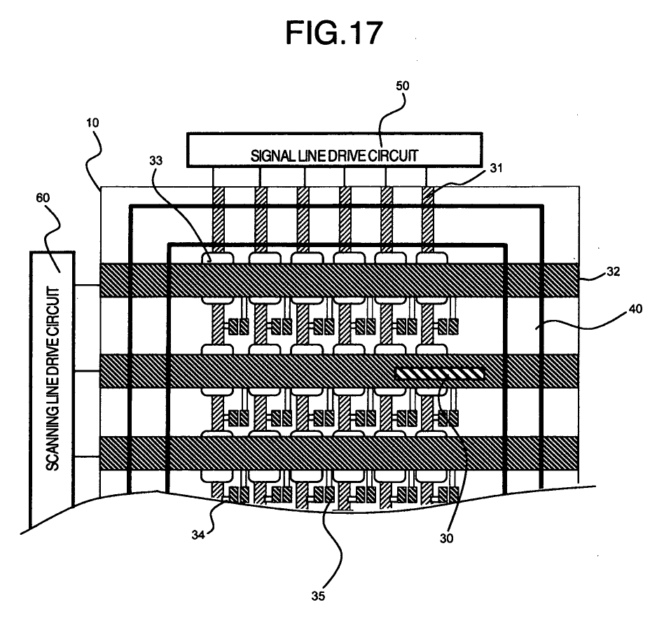

FIG. 17 shows embodiment 2 of the invention, wherein an image display device using a surface conduction type electron source is exemplified in schematic plan view form. In the figure, a plane of one substrate (cathode substrate) 10 having the electron source and a frame glass 40 are principally shown with omission of the other substrate (anode substrate) formed with phosphor materials.

Formed on the cathode substrate 10 are a signal electrode 31 connected to a signal line drive circuit 50, a scanning electrode 32 connected to a scanning line drive circuit 60 and arranged orthogonally to the signal line 31, an inter-insulator layer 33 for insulating the signal electrode 31 from the scanning electrode 32, contact electrodes 34 connected to the signal electrode 31 and scanning electrode 32, respectively, and an electron emission film 35 connected to the contact electrodes 34, having a crack therebetween. The cathode of the invention is featured in that an alkaline glass having a modifier component of an alkaline metal oxide or alkaline earth metal oxide is added to the electron emission film 35.

In the image display device using the surface conduction type electron source, a voltage is applied across the crack in the electron emission film 35 and part of electrons emitted from one portion of electron emission film 35 are extracted by a high voltage applied to the phosphor screen to cause phosphor materials to luminesce. The amount of electron emission can be increased by lowering the work function of the electron emission film and therefore, it is effective to lower the work function by adding an alkaline glass having a modifier component of an alkaline metal oxide or alkaline earth metal oxide to the electron emission film 35.

### Embodiment 3

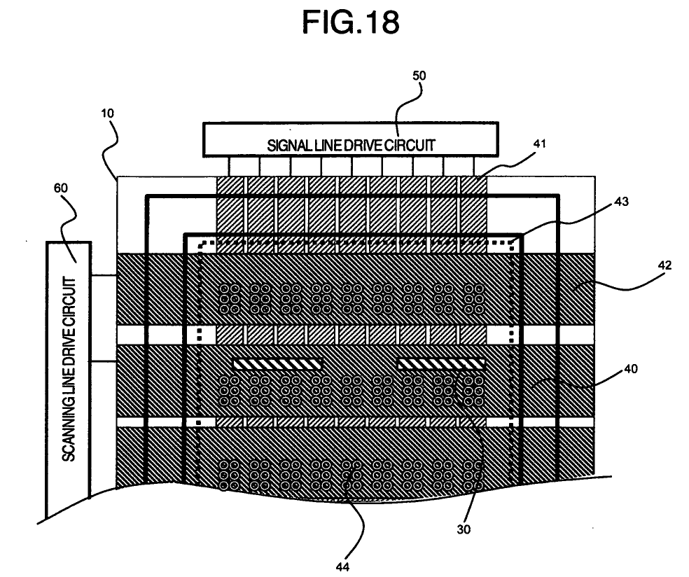

FIG. 18 shows embodiment 3 of the invention, wherein an image display device using a field emission type electron source is exemplified in schematic plan view form. In the figure, a plane of one substrate (cathode substrate) 10 having the electron source and a frame glass 40 are principally shown with omission of the other substrate (anode substrate) formed with phosphor materials.

Formed on the cathode substrate 10 are a signal electrode 41 connected to a signal line drive circuit 50, a scanning electrode 42 connected to a scanning line drive circuit 60 and arranged orthogonally to the signal electrode 41, an inter-insulator layer 43 for insulating the signal electrode 41 from the scanning electrode 42 and an array 44 of electric field emission chips formed on the signal electrode 41 (or scanning electrode 42). The cathode of the invention is featured in that an alkaline glass having a modifier component of an alkaline metal oxide or alkaline earth metal oxide is coated or added to the field emission chips 44.

In the image display device using the field emission type electron source, electric fields are concentrated on the tip of the field emission chip 44 to extract electrons emitted on the basis of the field emission phenomenon, thereby causing phosphor materials to luminesce. The amount of electron emission can be increased by lowering the work function of the electron emission chip 44 and therefore, it is effective to lower the work function by coating or adding to the electron emission chip 44 an alkaline glass having a modifier component of an alkaline metal oxide or alkaline earth metal oxide.

It should be further understood by those skilled in the art that although the foregoing description has been made on embodiments of the invention, the invention is not limited thereto and various changes and modifications may be made without departing from the spirit of the invention and the scope of the appended claims.

1. A display device comprising:
a cathode substrate having electron sources for emission of electrons formed in array; and
an anode substrate formed with phosphor materials which are excited to luminesce by electrons emitted from said electron sources, wherein
said electron sources include an alkaline metal or alkaline earth metal, and any one of boron, aluminum, silicon, germanium and phosphorus.

2. A display device according to claim 1, wherein said electron source includes the alkaline metal or alkaline earth metal, and boron, aluminum or silicon.

3. A display device according to claim 1, wherein said electron source includes the alkaline metal or alkaline earth metal, and silicon.

4. A display device according to claim 1, wherein said electron source includes any one of cesium, rubidium, potassium, sodium and lithium.

5. A display device according to claim 1, wherein said electron source includes two elements among cesium, rubidium, potassium, sodium and lithium at the same molar mass.

6. A display device according to claim 1, wherein said electron source includes cesium or potassium.

7. A display device according to claim 1, wherein said electron source includes cesium and potassium at the same molar mass.

8. A display device according to claim 1, wherein said electron source includes any one of barium, strontium, calcium and magnesium.

9. A display device according to claim 1, wherein said electron source includes barium.

10-12. (canceled)
